(19) United States
(12) Patent Application Publication
(10) Pub. No.: US 2025/0153923 A1
(43) Pub. Date: May 15, 2025

(54) APPARATUS AND METHOD FOR MIXING AND CONSUMING ON-DEMAND BEVERAGE COMPRISING LIQUIDS AND INGREDIENTS

(71) Applicants: Ramadevi NIMMANAPALLI, Tirupati (IN); Sreenivasa Reddy DONAPATY, SAMMAMISH, WA (US)

(72) Inventors: Ramadevi NIMMANAPALLI, Tirupati (IN); Anjole DONAPATY, Tirupati (IN)

(21) Appl. No.: 18/715,043

(22) PCT Filed: Nov. 25, 2023
(86) PCT No.: PCT/IB2023/061885

§ 371 Date: May 30, 2024

(30) Foreign Application Priority Data
Nov. 25, 2022 (IN) 202241067995

(51) Int. Cl. B65D 81/32; A23L 2/02; A23L 2/38; A23L 2/56; A47J 31/40; A47J 31/46; B01F 23/40; B01F 23/45; B01F 23/50; B01F 35/71; B01F 101/14; B01F 101/16; C12G 3/06

(52) U.S. Cl. CPC B65D 81/3222; A23L 2/02; A23L 2/38; A23L 2/56; A47J 31/402; A47J 31/404; A47J 31/461; B01F 23/405; B01F 23/452; B01F 23/511; B01F 35/7131; B01F 35/7138; C12G 3/06; B01F 2101/14; B01F 2101/16

(57) ABSTRACT

Embodiments of the present disclosure relate to a portable packaging apparatus that isolates and mixes one or more ingredients on demand to prepare hot and cold beverages. The packaging apparatus comprises a first compartment to store the one or more ingredients and receive one or more ingredients from a second compartment for preparing a cocktail, mocktail, or beverage on demand. The prepared cocktail, mocktail, or beverage is then facilitated to flow out to be consumed by the customer. The packaging apparatus for preparing and consuming hot and cold beverages on demand is portable, can be disposable, and ready for transport and the retail market. The one or more ingredients get dispensed by an application of slidable force, twist, push, press, pull or piston press force initiated by unlocking, tearing, cap removing, unsealing, wall disintegration in order to facilitate on demand mixing of the one or more ingredients to procure any beverage of choice.

### FIELD OF INVENTION

The embodiments of the present disclosure generally relate to a field of packaged beverages that are specifically to facilitate on demand beverage(s) that include alcoholic and/or non-alcoholic beverages known as cocktails and mocktails including coffee and tea. More particularly, the present disclosure relates to an apparatus and a method for storing one or more constituents including solid and/or liquid ingredients separately, providing a provision for on-demand mixing of ingredients, and enabling cocktails and mocktails to be available as on-demand portable retail products without any need for pre-mixing the ingredients.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In general, cocktail may refer to an alcoholic drink made with spirit(s) and certain ingredients such as fruit juices, and the like. Further, there may be non-alcoholic drink, which may be referred to as mocktails, and may be made of mixing ingredients and fruit drinks or fruit flavoured drinks. Coffee and tea though not generally classified under mocktails may fit into the definition of mocktails and may involve one or more solid and/or liquid ingredient admixture. Hence, as an embodiment of the present disclosure, cocktail and mocktail reference includes all varieties of coffee and tea. The cocktails or mocktails may be served freshly made in a bar or a dry bar respectively or premixed and bottled and ready to use either chilled/frozen/or at room temperature. However, there may be no bottled or packaged beverage that can accommodate a) an isolation of constituent ingredients and b) on-demand fresh mixing and flow control of mocktails or cocktails for consumption anywhere and at any time. The fresh mixture may be superior and offers distinct experience of diverse screened or compatible flavours to taste panels. Fresh cocktails and mocktails may be offered in stationary facilities limiting access by factors like distance, affordability, and hours of operation. Making the cocktails and mocktails portable and retail products that can be made on demand would address all the above limitations. In addition, some cocktails/mocktails may be preferred in aeriated form, and once popped open these drinks start losing bubbly nature.

Conventional apparatus may provide a fruit concentrate dispensing apparatus for mixing a fruit concentrate and still water which includes a mixing chamber. When the apparatus is operated, the fruit concentrate and water enter the mixing chamber and directly impinge on one another so as to mix and give a properly mixed drink. Another conventional apparatus provides a beverage dispensing valve including a manifold that receives and dispense a first liquid and a second liquid. The manifold has a first flow channel through which the first liquid is conveyed and a second flow channel through which the second liquid is conveyed. A first shutoff assembly has a valve seal on a leg disposed in the first flow channel and a second shutoff assembly has a valve seal on a leg disposed in the second flow channel. The first liquid and second liquid mix downstream to form a mixed beverage. Yet another conventional apparatus provides a beverage dispenser. The beverage dispenser includes dispenser beverage inlet connected to a source of a beverage component and dispenser carbonated liquid inlet connected to a source of a carbonated liquid, a mixing means for mixing one or more beverage components with at least one carbonated liquid into a final beverage, using one or more double jet mixers. Another conventional apparatus may provide an electronically controlled multi-flavour drink dispenser having one or two diluent lines and a plurality of concentrate lines leading to a mixing nozzle, flow valves for switching the flow on and off in each line, flow adjustment means, and electronic control means operated by a control panel.

However, the conventional apparatus may not provide instant automated or packaged as a portable complete product that can be sold as a cocktail or mocktail retail product. Further, the conventional apparatus may not provide flow control in packaged drinks, and may only be premixed at best with no ‘on demand’ mixing ability or customization among ingredient options. Furthermore, the conventional apparatus may not provide a means for the aerated drinks to retain bubbly nature after popped open. The conventional apparatus may not accommodate freshness in bottled or packaged cocktail/mocktails(s) making on demand drink experience better both in terms of mixing as well as flow control of the spirits, juices, drinks, ingredients, and the like. Furthermore, the ability to customize the ingredients expands the reach to anywhere/anytime and enhances customer service qualitatively while simplifying packaging complexities.

Disclosed in WO2016120834A2 are methods, systems, and appliances that allow a user to prepare a wide array of different types of customizable beverages using various combinations of base liquids and ingredients. These methods, systems and appliances allow users to design and prepare various types of beverages, both carbonated and non-carbonated, that incorporate various ingredients. These methods, systems, and appliances allow for such beverages to be prepared at varying pressures and temperatures, allowing users to custom-design individual servings of beverages such as beers, wines, ciders, and spirits. Contrary to WO2016120834A2, our invention discloses a concise packaging that provides the opportunity to prepare customized cocktails and mocktails on demand and does not require any paraphernalia other than the product and entire product is a portable and/or a retail product. Moreover, WO2016120834A2 discloses pressure, temp, gas regulation options built in to a mixer that dispenses concentrated liquid that can be diluted and blended with flavourful ingredients before dispensing the beverage, while our product is not a dispenser by definition but a prepackaged product that holds ingredients isolated and ‘on demand’ facilitates a) manual mixing of isolated ingredients 2) provides for cooling or heating of ingredient(s) based on the type of drink 3) controls ingredient outlets to customize the ingredients choice to be mixed 4) control. controls outflow for consumption-all in one.

Disclosed in U.S. Pat. No. 10,486,953B2 is a beverage dispenser that has a housing in which a first liquid inlet is connectable to a base liquid source. The housing also contains a second liquid inlet connectable to a base liquid source or to a pressurized gas source and a pair of jet mixers. First and second liquid lines connect the respective first and second liquid inlets and jet mixers. A first ingredient container contains a first beverage ingredient, the pod or capsule provided in a first ingredient container receiving means, and a second ingredient container containing a second beverage ingredient, the ingredient container provided in a second ingredient container receiving means. The first and second ingredient containers are configured such that upon providing a liquid stream in the respective liquid lines, the beverage ingredient is discharged from the ingredient container into the liquid stream. A beverage outlet is in liquid communication with the jet mixer. In U.S. Pat. No. 10,486,953B2, the mixing facilitation is disclosed in the claims but the dispensed mixed beverage is neither portable nor a retail product that is packaged to be transported in a non-mixed form/meant for stationary facilities only. Disclosed in U.S. Pat. No. 8,960,500B2A is a beverage dispenser for combining a number of micro ingredients, macro-ingredients, and water streams. The beverage dispenser may include a micro mixing chamber for mixing a number of the micro-ingredients and the water into a micro-ingredient stream and a macro-mixing chamber for mixing the micro-ingredient stream, the macro-ingredients, and the water into a combined stream. Thus, the micro ingredients and macro ingredients get mixed separately first and then get dispensed together. However, contrary to our invention, there is no facilitation of procuring a packaged product that facilitates isolation and on demand mixing, heating, cooling and consumable outflow; all in one either in U.S. Pat. No. 10,486,953B2 or in U.S. Pat. No. 8,960,500B2A.

Disclosed in U.S. Pat. No. 3,727,799A is a construction for preparing mixed drinks including a plurality of separate compartments holding a variety of liquid ingredients. Dispensing apparatus associated with each compartment can be individually operated for removing portions of the ingredients from outlet means positioned at a common location. A selector means is associated with the construction, and actuating means for the dispensing apparatus are moved to operating position in response to movement of the selector means. Drive means are provided for automatically achieving dispensing of the desired ingredients. A mixing station is provided for alternative use with the mixing means being driven from the same source as the drive means used for achieving dispensing action. On the contrary, our invention provides a prepackaged portable/retail beverage that facilitates mixing of all or customized, ingredients on demand that can be consumed directly with no additional paraphernalia requirements.

Therefore, there is a need in the art to provide apparatus and methods that can overcome the shortcomings of the existing prior art, by providing an apparatus and a method for mixing and dispensing packaged on-demand alcoholic and/or non-alcoholic beverages comprising one or more liquids and one or more ingredients.

### OBJECTS OF THE PRESENT DISCLOSURE

Some of the objects of the present disclosure, which at least one embodiment herein satisfies are as listed herein below.

It is an object of the present disclosure to provide an apparatus and a method for mixing and dispensing an ‘on-demand’ alcoholic and/or non-alcoholic beverages comprising one or more liquids and one or more ingredients.

It is an object of the present disclosure to provide an apparatus and a method for on demand beverage with a flow control to keep drinks cool and aerated longer.

It is an object of the present disclosure to provide an apparatus and a method for a common unlocking twist/pull mechanism for mixing isolated separate ingredients and/or liquids.

It is an object of the present disclosure to provide an apparatus and a method for allowing a user for performing press release motion of a value to unlock the straw access to drink, which may be on demand function.

It is an object of the present disclosure to provide an apparatus and a method for protecting access to ball motion in socket with a safety lock attached to straw end access that controls the ball movement for drinking the beverages straight out of the apparatus.

It is also an object of the present disclosure to provide an apparatus and a method for preparing beverages on-demand provided with a vent that can be accessed by opening or closing the slide cap door for drinking the prepared beverage.

It is an object of the present disclosure to provide an apparatus and a method for enabling retail marketing of cocktails and mocktails anywhere and anytime.

It is also an object of the present disclosure to provide an apparatus and a method for brewing cold or hot coffee simply by purchasing a prepackaged retail product that contains isolated mixing coffee powder, warm or chilled milk, sugar, and essences and using facilitated on demand mixing and following optional heating and cooling steps.

It is also an object of the present disclosure to provide an apparatus and a method for enabling extension of cooling period, heating, closure to retain temperature and bubbly nature.

It is also an object of the present disclosure to provide an apparatus and a method for enabling customized selection of ingredients to be mixed extending personal choice facility to individual customer.

It is also an object of the present disclosure to provide an apparatus and a method for enabling closure of vent and out flow till mixing is completed by customer after unsealing the product.

The present disclosure allows to prepare instant on-demand alcoholic or non-alcoholic beverages using isolated liquid and/or solid ingredients without a need for any assistance from another person, or paraphernalia.

### SUMMARY

This section is provided to introduce certain objects and aspects of the present invention in a simplified form that are further described below in the detailed description. This summary is not intended to identify the key features or the scope of the claimed subject matter. The foregoing summary is illustrative only and is not intended to be in any way limiting. In addition to the illustrative aspects, embodiments, and features described above, further aspects, embodiments, and features will become apparent by reference to the drawings and the following detailed description.

In an aspect, the present disclosure discloses a pre-packaged apparatus for storing isolated solid and/or liquid ingredients to be transported and sold as retail product anywhere and anytime that can be ‘on demand’ mixed and consumed. The apparatus includes at least one first compartment configured to store one or more first alcoholic liquids, and/or one or more first non-alcoholic liquids, and/or one or more first ingredients. Further, the apparatus includes a second compartment coupled to at least one first compartment, is configured to store one or more second alcoholic liquids, and/or one or more second non-alcoholic liquids, and/or one or more second ingredients. Furthermore, the apparatus includes one or more ball sockets slidably coupled to the second compartment, is configured to twist-motion control of a flow of beverage received from the at least one first compartment. Additionally, the apparatus includes a tubular structure coupled to the one or more ball sockets, is configured to dispense a beverage. The tubular structure comprises a removably attached safety lock and a protrusion member. Further, the apparatus includes wheel member comprising a screw (204) and a conical lock member. Furthermore, the wheel member is configured to receive rotating input from a user to release at least one of the one or more second alcoholic liquids, the one or more second non-alcoholic liquids, and the one or more second ingredients, into the at least one first compartment to create an admixture with at least one of the one or more first alcoholic liquids, the one or more first non-alcoholic liquids, and the one or more first ingredients, before dispensing the admixture. Upon rotating the wheel member, the screw loosens the conical lock member to cause the release of at least one of the one or more second alcoholic liquids, the one or more second non-alcoholic liquids, and the one or more second ingredients.

Alternatively flow control provision can be an aligned outflow control from first compartment through second compartment with an intermediary tearable seal that is further controlled by a vent provision in the cap structure that closes the first and second compartment opening.

Alternative to twist motion wheel control of ‘on demand’ mixing; a tubular structure or structures that receives push/press/or piston manual pressure would release one or more solid or liquid ingredients from second compartment into first compartment to make cocktail or mocktail including coffee or tea.

In another embodiment, the second compartment is coupled to at least one first compartment via a locking member comprising a grip beaded on outer diameter around neck region to attach to the at least one first compartment.

In another embodiment, the ingredients correspond to fruit juice, drinks, aerated drinks, flavoured drinks, flavours, alcoholic ingredients, and the like.

In another embodiment, the twist-motion control of the flow retains at least one of the one or more alcoholic liquids, the one or more non-alcoholic liquids, the and one or more ingredients sealed and release as required.

In yet another embodiment, the flow is an on-demand flow, and the admixture is proportional to the flow, where the one or more ball sockets motion aligns to the proportional release of least one of beverage.

In yet another embodiment, when there is no wheel member, the at least one of the one or more second alcoholic liquids, the one or more second non-alcoholic liquids, and the one or more second ingredients, is released into the at least one first compartment, by receiving a pressure input from the user on the second compartment, after opening a strip.

In another embodiment a peelable seal that is strategically placed to seal contents; with a connecting slot through or around second compartment would release contents after mixing and peeling steps after opening a strip.

In another embodiment a cap is coupled to at least one first or second compartment via a locking member comprising a grip beaded on outer diameter around neck region to attach to both compartments that facilitates slidable sipper opening on demand and a vent

In yet another embodiment, when the at least one first compartment is a sachet, the second compartment is attached to the sachet, and wherein the sachet comprises at least one of the one or more second alcoholic liquids, the one or more second non-alcoholic liquids, and the one or more second ingredients in a storage containers comprising a string, and wherein the storage containers are ruptured when the second compartment is opened and subsequently receiving a pull input from the user, via the string.

In another aspect, the present disclosure provides a method for mixing and dispensing an on-demand beverage comprising one or more liquids and one or more ingredients. The method includes storing at least one of one or more first alcoholic liquids, one or more first non-alcoholic liquids, and one or more first ingredients, using at least one first compartment. Further, the method includes storing at least one of one or more second alcoholic liquids, one or more second non-alcoholic liquids, and one or more second ingredients one or more apertures associated with a second compartment. The second compartment is coupled to at least one first compartment. Furthermore, the method includes a twist-motion controlling a flow of at least one of the one or more alcoholic liquids, the one or more non-alcoholic liquids, and the one or more ingredients, from the at least one first compartment, using the one or more ball sockets slidably coupled to the second compartment. Additionally, the method includes dispensing a beverage using a tubular structure coupled to the one or more ball sockets. The tubular structure comprises a removably attached safety lock and a protrusion member. Further, the method includes receiving one or more rotating inputs from a user via the a wheel member to release at least one of the one or more second alcoholic liquids, the one or more second non-alcoholic liquids, and the one or more second ingredients, into the at least one first compartment for creating an admixture with at least one of the one or more first alcoholic liquids, the one or more first non-alcoholic liquids, and the one or more first ingredients, before dispensing the admixture.

In another aspect a tubular structure or structures is/are designed to receive pressure and help ‘on demand’ mixing by releasing one or more solid or liquid ingredients into first compartment by unlocking bottom floor or moving compartment(s) contents downwards into first compartment.

In another aspect, a peelable seal placed on the second compartment holds the first compartment contents sealed and after mixing is complete can be pealed to make the cocktail or mocktail or coffee or tea ready to flow to be consumed. The present disclosure also provides an apparatus that enables the user to brew tea and coffee by placing the apparatus on a detachable mount provided with a wire. The wire of the mount can be plugged into a socket for providing electric supply (AC/DC) to the apparatus. The user can plug the wire into any socket and place the apparatus on the mount in order to boil water or milk for brewing tea or coffee.

In another aspect the slidable outflow and vent control door can facilitate beverage outflow to be consumed after the mixing and unsealing steps are complete by opening the outflow slot and vent.

### BRIEF DESCRIPTION OF THE ACCOMPANYING DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1A illustrates a perspective view (100A) of an apparatus for mixing and dispensing an on-demand beverage comprising one or more liquids and one or more ingredients, in accordance with an embodiment of the present disclosure.

FIG. 1B-1D illustrates an exploded representation (100B-100D) of an apparatus for mixing and consuming an on-demand beverage comprising one or more liquid ingredients and one or more solid ingredients, an exploded representation (100B) of a first compartment and a second compartment of the apparatus for mixing and consuming an on-demand beverage comprising one or more liquid ingredients and one or more solid ingredients, and an exemplary representation (100C) of the apparatus for mixing and consuming an on-demand beverage comprising one or more liquid ingredients and one or more solid ingredients, in accordance with an embodiment of the present disclosure.

FIG. 2A illustrates an exploded view of a second compartment, in accordance with an embodiment of the present disclosure.

FIGS. 2BA, 2BC, 2BD, and 2BE illustrate a front view, a rear view, a top view, and bottom view of a second compartment, in accordance with an embodiment of the present disclosure.

FIGS. 2CA, 2CB, 2CC, 2CD, 2CE and 2CF illustrate a perspective view, a front view, a rear view, a side view, a top view, and a bottom view of an alternate second compartment, in accordance with an embodiment of the present disclosure.

FIGS. 2DA, 2DB, 2DC, and 2DE illustrate a perspective view, a front view, a side view, and a top/bottom view of an alternative first compartment, in accordance with an embodiment of the present disclosure.

FIG. 3 illustrates a flow diagram representation (300) depicting a method for mixing and dispensing an on-demand beverage comprising one or more liquids and one or more ingredients, in accordance with an embodiment of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Various embodiments of the present disclosure provide an apparatus and a method for storing isolated solid or liquid ingredients of choice identified to make a specific cocktail or mocktail drink including coffee or tea and facilitate prepackaged form transport and be sold as retail product. Once customer purchases he/she can make respective beverage on-demand by mixing and consuming on-demand. The present disclosure provides an apparatus and a method for storing selected ingredients for individual beverage portions in isolated form and facilitates on demand beverage making capacity with a flow control to keep drink cool and aeriated longer. The present disclosure provides an apparatus and a method for a common unlocking twist mechanism for mixing isolated ingredients and/or liquids. The present disclosure provides an apparatus and a method for allowing a user for performing press release motion of a value to unlock the straw access to drink, which may be on demand function. The present disclosure provides an apparatus and a method for protecting access to ball motion in socket with a safety lock attached to straw end access that controls the ball movement. The present disclosure allows to prepare instant alcoholic or non-alcoholic beverages without a need for any assistance from another personal, and without losing bubbly nature and freshness. The present disclosure allows for a peelable seal positioned on second compartment to contain the first compartment contents sealed till mixing is complete and when peeled will make ready to drink beverage available. The present disclosure provides for a coupling between first compartment and second compartment and/or between second compartment and cap depending on the beverage of choice and preselected respective solid or liquid ingredients. The present disclosure provides a cap that can be removed for adding ice cubes and sliding downward movement of compartments also provide space for ice cube facility. The present disclosure provides for a sliding door component that controls fluid out flow and vent facilitating consumption and retaining temperature longer.

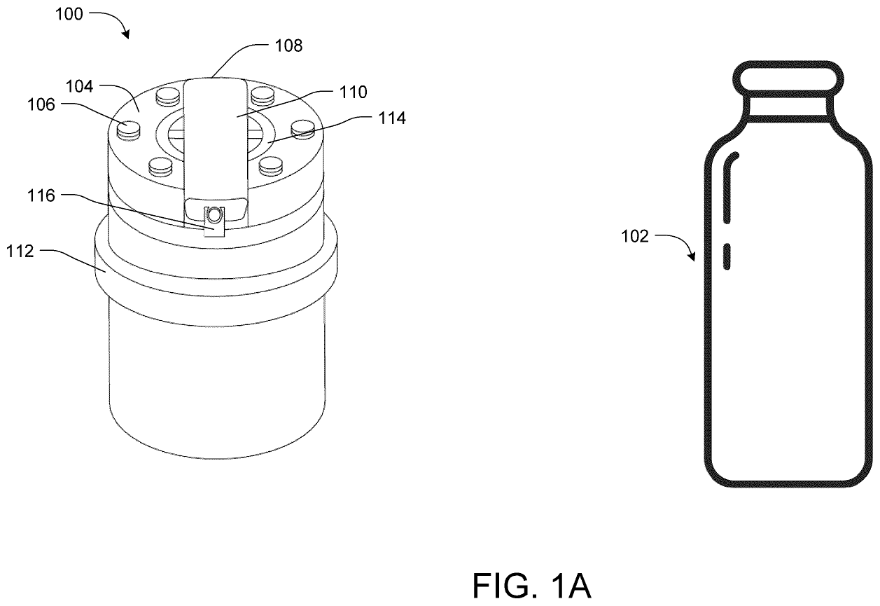

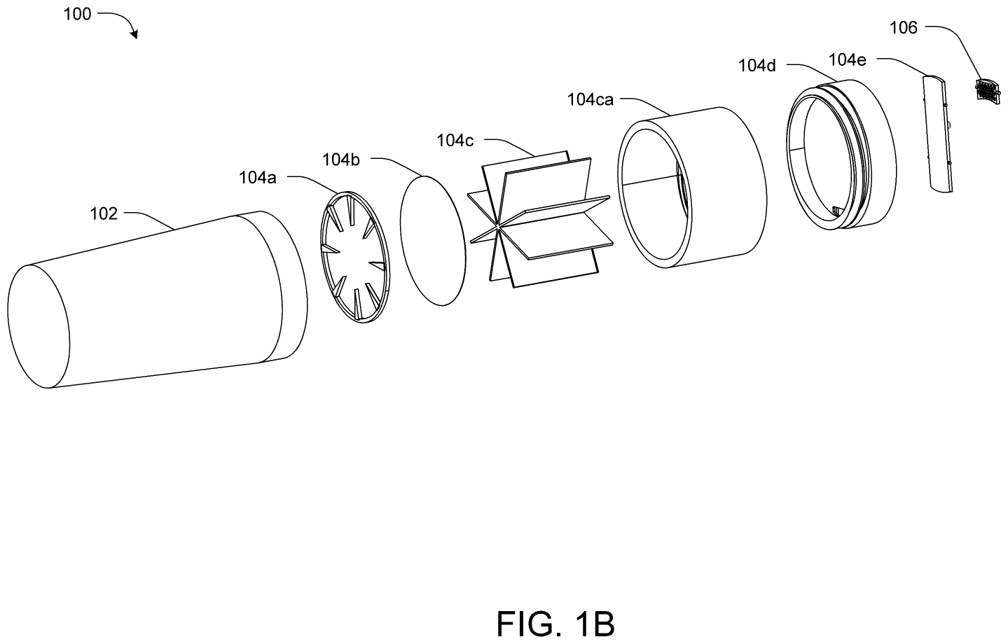

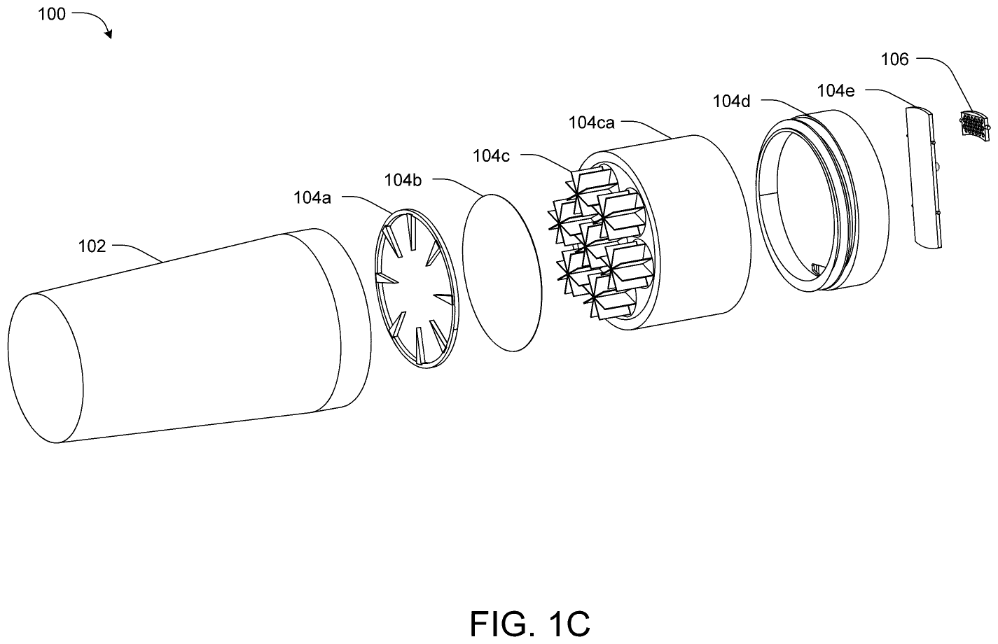

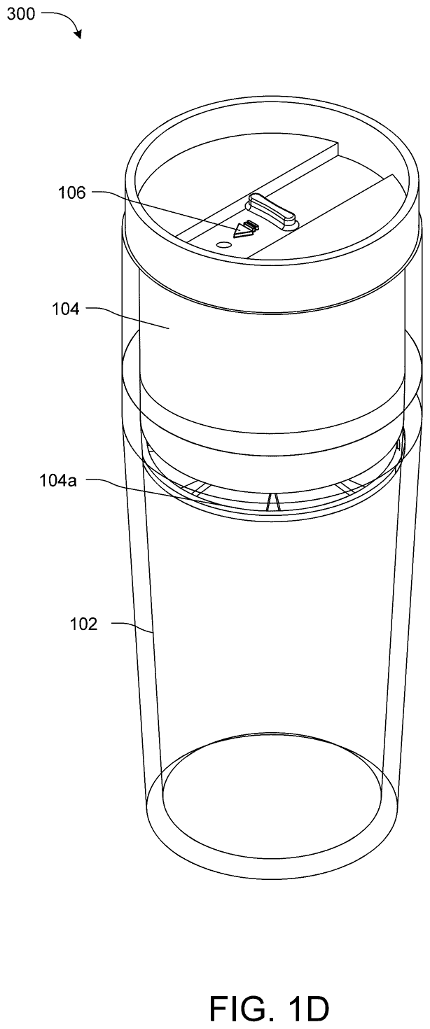

FIG. 1A illustrates a perspective view of an apparatus 100 for storing one or more individual solid and or liquid ingredients specific for selected beverage in isolation for transport and retail sale and facilitating on demand mixing and consumption by customer, in accordance with an embodiment of the present disclosure.

The apparatus 100 may include at least one first compartment 102, a second compartment 104. The first compartment 102 may correspond to, but is not limited to, one or more bottles, cans, packets, sachets, tetra packets, and the like. The first compartment 102 may include different shapes and size depending on a utility for specific beverage/drink. The second compartment 104 may include one pointed projections 104a, one or more chambers 104c with an outer wall 104ca, one or more ball sockets 108, a tubular structure 110, locking member 112, a cap 104d, a slidable door for sipper slot access and vent 104e, and a safety lock 106, a wheel member 114, and a safety lock 116. The second compartment 104 may be coupled to at least one first compartment 102. In some implementations, the at least one first compartment 102 may not be associated with/coupled to the second compartment 104. In some implementations, the second compartment 104 may be coupled to a cap of the at least one first compartment 102.

In an embodiment, the at least one first compartment 102 may store at least one of one or more first alcoholic liquids, one or more first non-alcoholic liquids, and first one or more ingredients. In an embodiment, the ingredients may correspond to, but are not limited to, fruit juices, drinks, aerated drinks, alcoholic ingredients, flavoured drinks, and the like. For example, the apparatus 100 may be directly attached to one or more bottles, packets, sachets, tetra packets, and the like. The second compartment 104 may include a screw on grip as a locking member 112 (e.g., cap), beaded on outer diameter around neck region to attach to the at least one first compartment 102.

In an embodiment, the second compartment 104 may store at least one of one or more second alcoholic liquids, one or more second non-alcoholic liquids, and one or more second ingredients in the one or more apertures 106 associated with the second compartment 104.

In an embodiment, the one or more ball sockets 108 may be slidably coupled to the second compartment 104. For simplicity, FIG. 1 may include one ball socket, however, it is to be appreciated that there may be more than one ball socket, based on the requirement. The one or more ball sockets 108 may twist-motion control a flow of a beverage received from the at least one first compartment 102. In an embodiment, the beverage may include, but is not limited to, an alcoholic beverage, a non-alcoholic beverage, and the like. For example, cocktails and mocktails, and the like. In an embodiment, the twist-motion control of the flow retains the beverage in a sealed position and release as required. In an embodiment, the flow is an on-demand flow, and the admixture is proportional to the flow where the one or more ball sockets 108 motion aligns to the proportional release of the beverage.

In an embodiment, the tubular structure 110 may be coupled to the one or more ball sockets 108. The tubular structure 110 may dispense the beverage. The tubular structure 110 may include a removably attached safety lock 116 and a protrusion member 202. For example, the one or more ball sockets 108 may be placed on the wheel member 114 or the one or more apertures 106 and one or more ball sockets 108 may be in fixed position. When the one or more ball sockets 108 are in a horizontal position, the one or more ball sockets 108 may lock in the beverage, and when the one or more ball sockets 108 are flipped to a vertical position, a ball in the one or more ball sockets 108 are may rotate to align out flow channel aligning the beverage outflow there by creation on demand flow control. For example, the tubular structure 110 may be a straw, which may extend inside the second compartment 104.

In an embodiment, wheel member may include a screw (not shown in FIG. 1) and a conical lock member (not shown in FIG. 1). The wheel member 114 may be configured to receive one or more rotating inputs from a user to release at least one of the one or more second alcoholic liquids, the one or more second non-alcoholic liquids, and the one or more second ingredients, into the at least one first compartment 102 to create an admixture with at least one of the one or more first alcoholic liquids, the one or more first non-alcoholic liquids, and the one or more first ingredients, before dispensing the admixture. Upon rotating the wheel member 114, the screw loosens the conical lock member 208 to cause the release of at least one of the one or more second alcoholic liquids, the one or more second non-alcoholic liquids, and the one or more second ingredients.

For example, the mixing of at least one of the one or more second alcoholic liquids, the one or more second non-alcoholic liquids, and the one or more second ingredients with at least one of the one or more first alcoholic liquids, the one or more first non-alcoholic liquids, and the one or more first ingredients is at an out flow (not shown in FIG. 1) chamber of the second compartment 104. For instance, the mixing is before dispensing the beverage, as premixing of the beverage makes the beverage stale.

In an embodiment of the present disclosure, as illustrated in FIGS. 1B-1D, the second compartment 104 of the apparatus may be a small cup with one or more chambers positioned inside a cup slot of the first compartment 102, as illustrated in the figures. The second compartment 104 is provided with a sealed cover. The sealed cover is tamper-proof and may be peeled off for drinking cocktails and mocktails. The sealed cover may also be torn apart by pointed projections 104a provided to rip through the sealed cover and provide access to the beverage. The one or more chambers may be aligned with the sealed cover and may be coupled to a plunger unit. In an aspect of the present disclosure, the plunger unit may be configured to be pushed in a downward direction for emptying the ingredients in the at least four chambers of the small cup into the first compartment 102 for preparation of the cocktails and mocktails. When pushed in the downward direction, the plunger unit may facilitate on demand mixing of isolated solid/liquid ingredients as required. In an aspect of the present disclosure, the apparatus may be configured to keep the ingredients cool for a longer duration both manually and automatically by facilitating addition of ice cubes/crushed ice before positioning the sealed cover. The apparatus is further provided with a slidable outflow and vent control door that can facilitate beverage outflow to be consumed after the mixing and unsealing steps are complete by opening the outflow slot and vent.

In an embodiment of the present disclosure, the apparatus may also be used for preparing chilled coffee and hot coffee. For preparing coffee, the user may need to fill the one or more chambers of the apparatus with ingredients that may include milk, sugar, coffee powder, and liquid essences. Every ingredient may be added to separate chambers of the apparatus. For making hot coffee, the user may need to screw out the first compartment 104 and heat the first compartment 104 in a microwave for sufficient time before making the first compartment a part of the apparatus. Then the one or more chambers containing milk, sugar, coffee powder, and liquid essences may need to be pushed by applying pressure on the plunger unit in order to mix milk, sugar, coffee powder, and liquid essences for brewing hot coffee. The same configuration can also be used as a disposable one-time pre-packaged apparatus. In an embodiment of the present disclosure, the apparatus 100 enables the user to brew tea and coffee by positioning the apparatus 100 on a detachable mount provided with a wire. The wire on the mount can be plugged into a socket for providing electric supply to the apparatus. The user can plug the wire into any socket and place the apparatus 100 on the mount in order to boil water or milk for brewing tea or coffee.

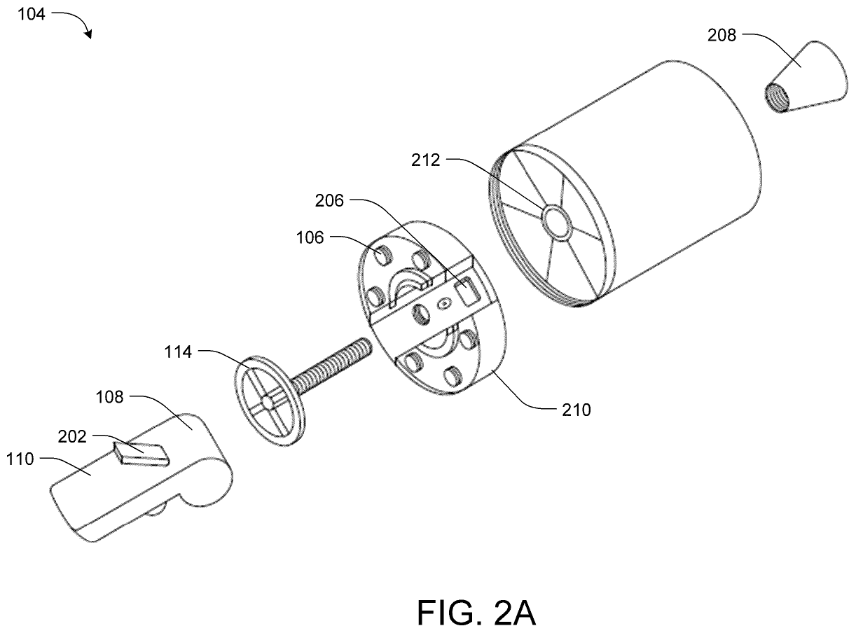

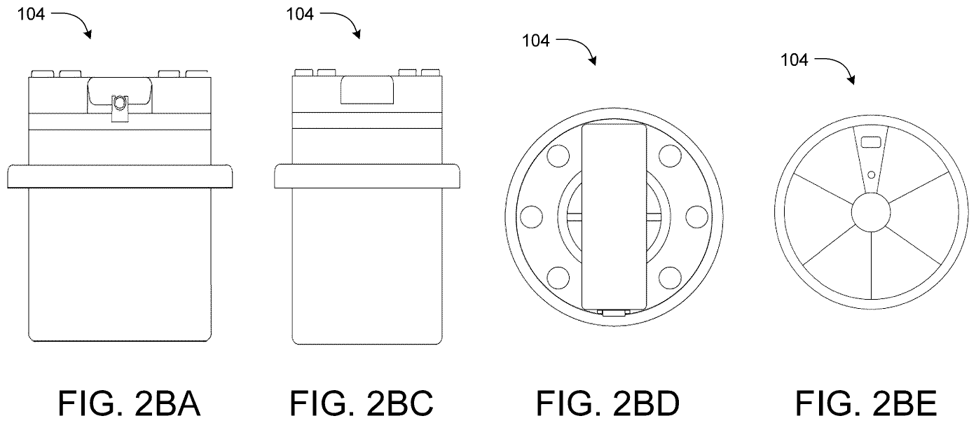

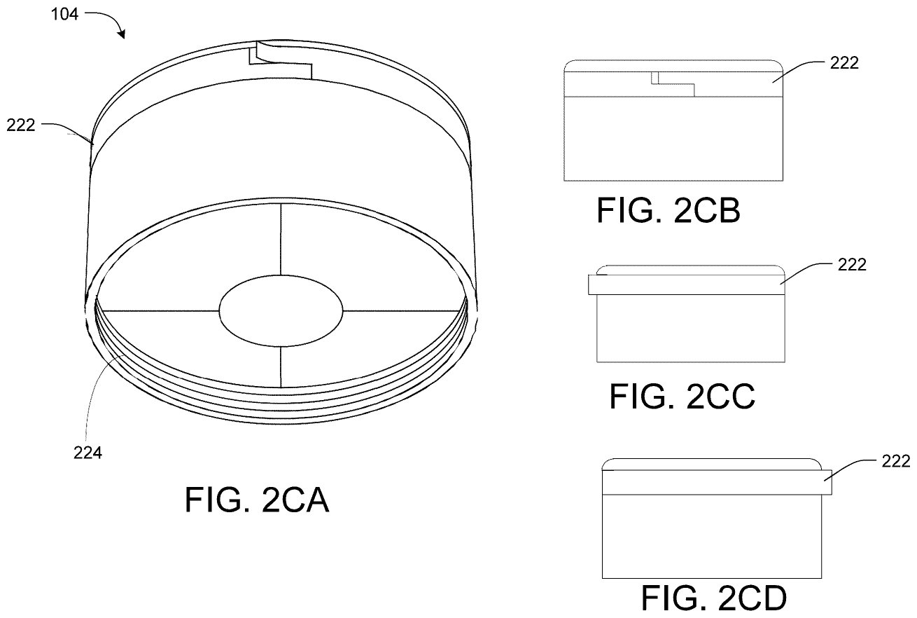

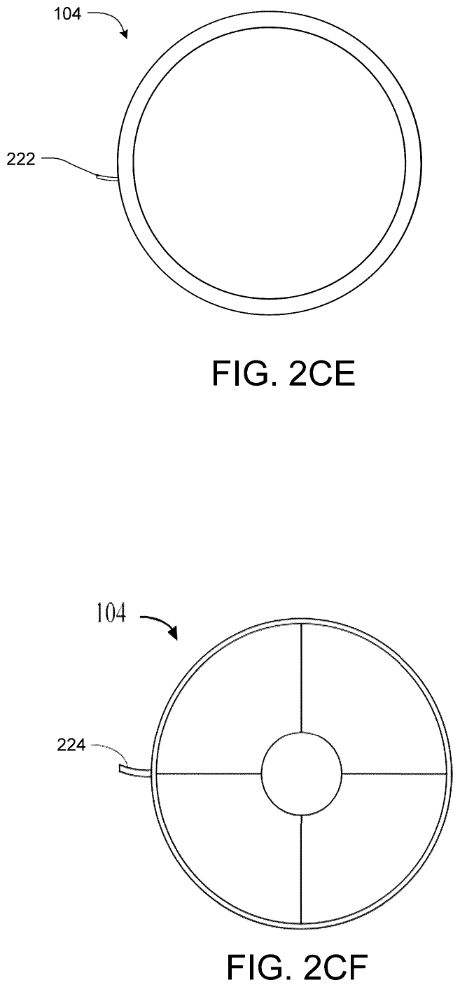

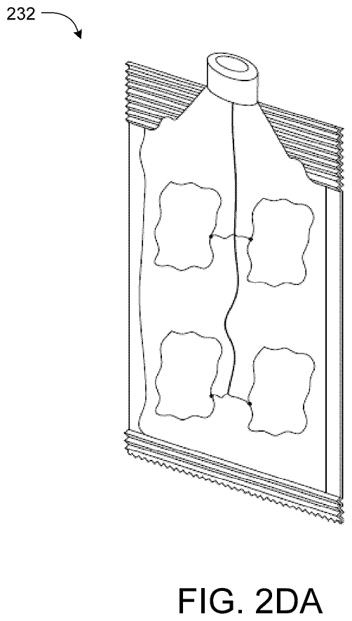

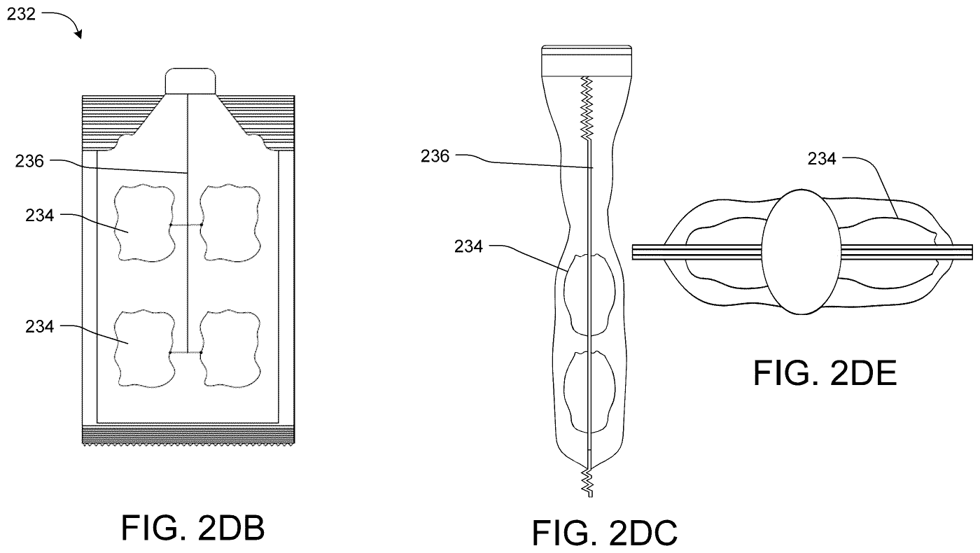

FIG. 2A illustrates an exploded view of the second compartment 104, in accordance with an embodiment of the present disclosure.

In an embodiment, the mixing of at least one of the one or more second alcoholic liquids, the one or more second non-alcoholic liquids, and the one or more second ingredients with at least one of the one or more first alcoholic liquids, the one or more first non-alcoholic liquids, and the one or more first ingredients is at an outflow chamber 210 of the second compartment 104. For instance, the mixing is before dispensing the beverage, as premixing of the beverage makes the beverage stale.

In an embodiment the one or more ball sockets 108 performs twist-motion control of the flow of the beverage using a protrusion member 202. The protrusion member 202 may be locked in a groove 206. The wheel member 114 is configured to receive one or more rotating inputs from a user to release at least one of the one or more second alcoholic liquids, the one or more second non-alcoholic liquids, and the one or more second ingredients, into the at least one first compartment 102 to create an admixture with at least one of the one or more first alcoholic liquids, the one or more first non-alcoholic liquids, and the one or more first ingredients, before dispensing the admixture, wherein upon rotating the wheel member 114, the screw loosens the conical lock member 208 to cause the release of at least one of the one or more second alcoholic liquids, the one or more second non-alcoholic liquids, and the one or more second ingredients.

Further, the wheel member 114 comprising a screw 204 and a conical lock member 208 may control the dispensing of at least one of the one or more second alcoholic liquids, the one or more second non-alcoholic liquids, and the one or more second ingredients, into the at least one first compartment 102.

Furthermore, the one or more apertures 106 may be separate chambers, which may include air tight closures 212.

FIG. 1D illustrates an exemplary representation (100C) of the apparatus for mixing and consuming an on-demand beverage comprising one or more liquid ingredients and one or more solid ingredients, in accordance with an embodiment of the present disclosure. Illustrated in FIG. 1C is the apparatus 100 for mixing and consuming an on-demand beverage comprising one or more liquids and one or more solid ingredients. The apparatus includes at least one first compartment 102 configured to store one or more first alcoholic liquids, and/or one or more first non-alcoholic liquids, and/or one or more first solid ingredients. Further, the apparatus 100 includes a second compartment 104 coupled to at least one first compartment 102, and configured to store one or more second alcoholic liquids, and/or one or more second non-alcoholic liquids, and/or one or more second ingredients. Furthermore, the apparatus 100 includes one or more ball sockets slidably coupled to the second compartment 104, is configured to twist-motion control of a flow of a beverage received from the at least one first compartment. Additionally, the apparatus 100 includes a tubular structure coupled to the one or more ball sockets, is configured to dispense a beverage. The tubular structure comprises a removably attached safety lock and a protrusion member a variation like popoff can also be flow release option. Further, the apparatus 100 includes wheel member comprising a screw (204) and a conical lock member. Furthermore, the a the wheel member is configured to receive rotating input from a user to release at least one of the one or more second alcoholic liquids, the one or more second non-alcoholic liquids, and the one or more second solid ingredients, into the at least one first compartment to create an admixture with at least one of the one or more first alcoholic liquids, the one or more first non-alcoholic liquids, and the one or more first solid ingredients, before dispensing the admixture. Upon rotating the wheel member, the screw loosens the conical lock member to cause the release of at least one of the one or more second alcoholic liquids, the one or more second non-alcoholic liquids, and the one or more second solid ingredients.

FIGS. 2BA, 2BC, and 2BD and 2BE illustrate a front view, a rear view, and a top view, and bottom view of the second compartment 104, in accordance with an embodiment of the present disclosure. The apparatus 100 may include a second compartment 104. The second compartment 104 may include the one or more apertures 106, the one or more ball sockets 108, the tubular structure 110, the locking member 112, the wheel member 114, and the safety lock 116.

Further, FIGS. 2CA, 2CB, 2CC, 2CD, 2CE and 2CF illustrate a perspective view, a front view, a rear view, a side view, a top view, and a bottom view of an alternate second compartment 104, in accordance with an embodiment of the present disclosure.

In an embodiment, the apparatus 100 may include a strip 222 which is a safety lock for a lid of the first compartment 102. For example, when a user holds hook on the strip 222 and peel away the strip 222, the one or more ball sockets 108 can be pushed down to open the first compartment 102. The at least one of one or more second alcoholic liquids, one or more second non-alcoholic liquids, and one or more second ingredients in the one or more apertures 106 associated with the alternate second compartment 104 dispense to the first compartment 102, when the alternate second compartment 104 is pushed down. Further, the strip 222 may be used to open the lid of the first compartment 102 in a twist motion. The strip 222 may function as a tamper proof plastic removable seal. The second compartment 104 may be secured to the first compartment 102 using a locking mechanism 224. When there is no wheel member 114, the at least one of the one or more second alcoholic liquids, the one or more second non-alcoholic liquids, and the one or more second ingredients, is released into the at least one first compartment 102, by receiving a pressure input from the user on the second compartment 104, after opening the strip 222.

FIGS. 2DA, 2DB, 2DC, and 2DE illustrate a perspective view, a front view, a side view, and a top/bottom view of an alternative first compartment 102, in accordance with an embodiment of the present disclosure. In an alternative embodiment, the first compartment 102 may include a sachet 232. The sachet 232 may include one or more partitions or storage containers 234 as shown in FIG. 2DB. The storage container 234 may include, but are not limited to, one or more alcoholic liquids, one or more non-alcoholic liquids, one or more ingredients, and the like. The storage container 234 may be ruptured into the sachet 232 by pulling a string 236 after opening a lid, as shown in FIG. 2DC. The second compartment 104 may be coupled to the sachet 232 directly, without additional components, as shown in FIGS. 2DC and 2DE.

In an embodiment, the sachet 232 may include a strip which is a safety lock for the lid of the sachet 232. For example, when a user holds hook on the strip and peel away the strip, the string 236 can be pushed down to open isolating chamber gates of the storage containers 234 in the sachet 232. Further, the strip may be used to open the lid of the sachet 232 in a twist motion.

As further illustrated in the figure, the second compartment 104 of the apparatus is provided with a sealed cover that can be ripped apart by a plurality of pointed projections 104a provided in the second compartment in order to mix the ingredients and consume the beverage. The one or more chambers of the second compartment may be aligned with the sealed cover and may be coupled to a plunger unit provided with one or more syringe components. In an aspect of the present disclosure, the plunger unit may be pushed in a downward direction for emptying the ingredients in the at least four chambers of the second compartment 104 into the first compartment 102 for preparation of the cocktails and mocktails with the help of the one or more syringe components. When pushed in the downward direction, the plunger unit may facilitate on demand mixing of isolated solid/liquid ingredients as required. In an aspect of the present disclosure, the apparatus may be configured to keep the ingredients cool for a longer duration both manually and automatically by facilitating addition of ice cubes/crushed ice before positioning the sealed cover.

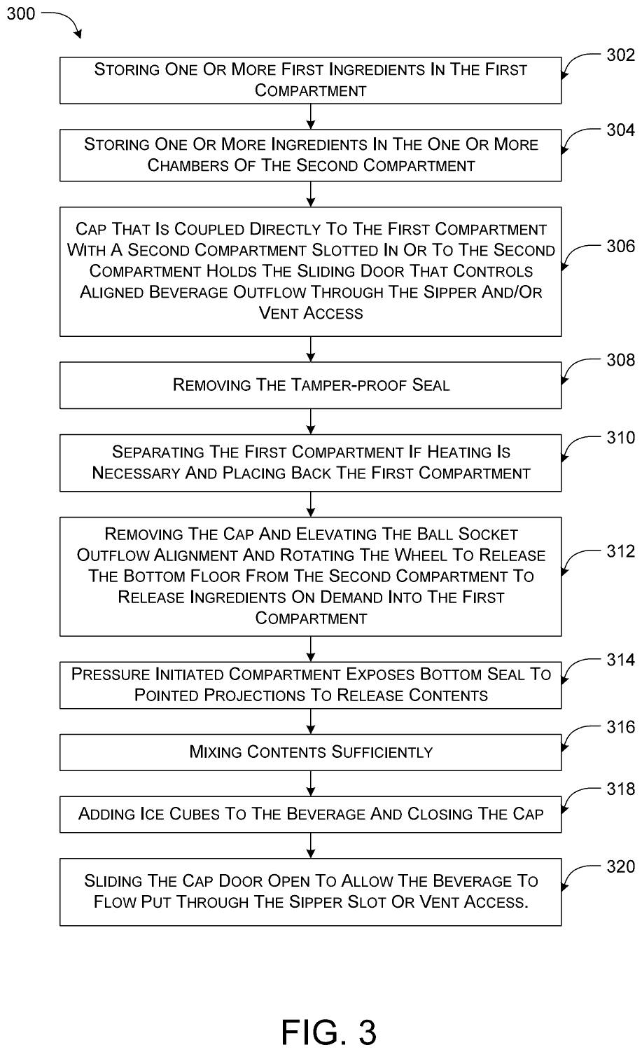

FIG. 3 illustrates a flow diagram representation depicting a method 300 for mixing and dispensing an on-demand beverage comprising one or more liquids and one or more ingredients, in accordance with an embodiment of the present disclosure.

At block 302, the method 300 includes storing, by the apparatus 100, at least one of one or more first alcoholic liquids, one or more first non-alcoholic liquids, and one or more first ingredients, using at least one first compartment 102.

At block 304, the method 300 includes storing, by the apparatus 100, at least one of one or more second alcoholic liquids, one or more second non-alcoholic liquids, one or more second ingredients in one or more apertures 106 associated with a second compartment 104. The second compartment 104 is coupled to at least one first compartment 102.

At block 306, the method 300 includes Cap that is coupled to directly to first compartment with the second compartment slotted in or to second compartment holds the ball socket outflow control hurdle and rotatable wheel control for ingredients release coupled to the second compartment.

At block 308, the method 300 includes removing, by the apparatus 100, the tamper-proof seal.

At block 310, the method 300 includes separating the first compartment if heating is necessary and placing back the first compartment.

At block 312, the method 300 includes removing the cap and elevating the ball socket outflow alignment and rotating the wheel to release the bottom floor from the second compartment or compartments to release ingredients on demand into the first compartment.

At block 314, the method 300 includes closing the ball socket sipper and mixing contents sufficiently. Further, at block 314, the method 300 also includes exertion of pressure on the compartments that exposes the bottom seal that is torn apart by the pointed projections 104a of the apparatus.

At block 316, the method 300 includes adding ice cubes, if needed, and closing the cap for sufficiently mixing contents. Further, at block 316, the method 300 includes opening the ball socket sipper sufficiently to consume the beverage and then closing the apparatus to retain the temperature of the beverage.

At block 318, the method 300 includes adding of ice cube, if needed, to the beverage and then closing the cap of the apparatus.

At block 320, the method 300 includes sliding the cap door open and the allowing the vent and sipper to facilitate an outflow of the beverage for consuming the beverage.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

### Advantages of the Present Disclosure

The present disclosure provides an apparatus and a method for storing selected one or more solid and/or liquid ingredients specific for each mocktail or cocktail including coffee or tea, in isolation, facilitating transport, retail sale, on demand mixing, and consumption.

The present disclosure provides an apparatus and a method for on demand beverage with a flow control to keep drink cool and aerated longer.

The present disclosure provides an apparatus and a method for a common unlocking twist mechanism for mixing isolated separate ingredients and/liquids.

The present disclosure provides an apparatus and a method for allowing a user for performing press release motion of a value to unlock the straw access to drink, which may be on demand function.

The present disclosure provides an apparatus and a method for protecting access to ball motion in socket with a safety lock attached to straw end access that controls the ball movement.

The present disclosure allows to prepare instant alcoholic or non-alcoholic beverages without a need for any assistance from another personal, and without losing bubbly nature and freshness.

1. A portable and retail packaging apparatus for storing and mixing one or more ingredients and consuming beverages on demand, the apparatus comprising:
at least one first compartment configured to store the one of one or more ingredients in a solid state or a liquid state;
a second compartment positioned inside the at least one first compartment, configured to store the one or more ingredients, and provided with one or more apertures or piercing enclosures or emptiable piston components or un-corkable or sealed parts to facilitate on demand mixing with the at least one of one or more solid or liquid ingredients of the at least one first compartment;
one or more ball sockets comprising a slidable vent on lid slidably coupled to a slidable cap configured to control a flow of a beverage through a vent that opens after a seal is broken for outflow;
a tubular structure coupled to the one or more ball sockets, or to the slidable cap, configured to dispense the beverage, wherein the tubular structure or the slidable cap is aligned to empty compartment or slot that permits outflow either through a tamper-proof ball and socket alignment or a tamper-proof controlled peelable top opening and permanently open bottom; and
one or more wheel members comprising one or more screws and at least one or more conical lock members, wherein the one or more wheel members are configured to receive one or more rotating inputs from a user to unlock one or more conical lock members to release at least one of the one or more solid or liquid ingredients into the at least one first compartment to facilitate on demand mixing of the at least one of one or more solid or liquid ingredients,
wherein the second compartment comprises a small cup with one or more chambers, positioned inside a cup slot of the first compartment, and coupled to one or more plunger units, configured to move in a downward direction for emptying the at least one of one or more ingredients in the one or more chambers of the second compartment into the first compartment for preparation of cocktails and mocktails by mixing the at least one of one or more ingredients,
wherein the second compartment comprises a small cup with one or more chambers, positioned inside a cup slot of the first compartment, and available for manually un sealing and mixing one or more solid or liquid ingredients, and
wherein the apparatus is configured to isolate and blend the one or more ingredients either in solid or liquid state for preparing an on-demand beverage by applying slidable force, twist, push, press, pull and piston press force initiated by unlocking, tearing, cap removing, unsealing, and wall disintegration of the apparatus.

2. The apparatus as claimed in claim 1, wherein the second compartment is slotted air tightly in directly or is coupled to at least one first compartment via a locking member comprising a grip beaded on outer diameter around neck region to attach to the at least one first compartment depending on the packaging and mixing fabrication necessities and their variations.

3. The apparatus as claimed in claim 1, wherein the ingredients are blended to make drinks comprising coffee, tea, fruit juice, aerated drinks, flavours, alcoholic drinks, and flavoured drinks.

4. The apparatus as claimed in claim 1, wherein the twist-motion control of the flow, the tamper-proof seal, and the cap retain the beverage in a sealed position and release as required.

5. The apparatus as claimed in claim 1, wherein the cap provides facility to manually mix the isolated one or more solid or liquid ingredients/and provide space to add ice cubes and a tamper-proof facility for the cap and the slidable seal of vent and a sipper slot.

6. The apparatus as claimed in claim 1, wherein there are tamper proof seals affixed to the cap, slidable flow control knob, and top seal for facilitating out flow to empty out the second compartment that is aligned to a sipper slot.

7. The apparatus as claimed in claim 1, wherein a plurality of dagger like projections are provided to unseal the second compartment to facilitate on demand mixing when pressure is applied on a top finger slot.

8. The apparatus as claimed in claim 1, wherein, when there is no wheel member, the at least one or more solid or liquid ingredients from the second compartment is released into the at least one first compartment of the one or more second alcoholic liquids, by applying a pressure either manually or with an intermediary piston or string coupled to the second compartment, after the tamper-proof seal is removed by opening a strip.

9. The apparatus as claimed in claim 1, wherein, when the at least one first compartment comprises a sachet with the second compartment attached to the sachet, and wherein the sachet comprises at least one of the one or more ingredients in storage containers comprising a string, and wherein the storage containers are ruptured when the second compartment is opened and subsequently receiving a pull input from the user, via the string.

10. A method for mixing and dispensing an on-demand beverage comprising one or more liquids and one or more ingredients, the method comprising:
storing, by an apparatus, one or more ingredients in a solid state and in a liquid state in at least one first compartment;
storing, by the apparatus, one or more ingredients in a solid state and in a liquid state in one or more apertures associated with a second compartment, wherein the second compartment is coupled to at least one first compartment;
twist-motion controlling, by the apparatus, a flow of a beverage received from the at least one first compartment, using the one or more ball sockets slidably coupled to the second compartment;
dispensing, by the apparatus, the beverage using a tubular structure coupled to the one or more ball sockets, wherein the tubular structure comprises a removably attached safety lock and a protrusion member; and
receiving, by the apparatus, one or more rotating inputs from a user via a wheel member to release the one or more ingredients into the at least one first compartment for creating an admixture with at least one of the one or more first alcoholic liquids, the one or more first non-alcoholic liquids, and the one or more first ingredients, before dispensing the admixture.

11. The method as claimed in claim 10, wherein the second compartment is coupled to the at least one first compartment via a locking member comprising a grip beaded on an outer diameter around neck region to attach to the at least one first compartment.

12. The method as claimed in claim 10, wherein the one or more ingredients are combines to prepare fruit juice, flavoured drinks, aerated drinks, and alcoholic drinks.

13. The method as claimed in claim 10, wherein the twist-motion control of the flow retains the beverage in a sealed position and release as required.

14. The method as claimed in claim 6, wherein the flow is an on-demand flow, and the admixture is proportional to the flow where the one or more ball sockets motion aligns to the proportional release of least one of the one or more alcoholic liquids, the one or more non-alcoholic liquids, the and one or more ingredients.
